(19) United States
(12) Patent Application Publication
(10) Pub. No.: US 2014/0204780 A1
(43) Pub. Date: Jul. 24, 2014

(54) WIRELESS DEVICE, ROUTER, WIRELESS SYSTEM, AND METHOD FOR HIGH-SPEED OPTIMIZATION OF WIRELESS TRANSMISSION

(71) Applicants: Kenji Yamada, Tokyo (JP); Genichirou Sekine, Tokyo (JP)

(72) Inventors: Kenji Yamada, Tokyo (JP); Genichirou Sekine, Tokyo (JP)

(21) Appl. No.: 14/117,299

(22) PCT Filed: May 11, 2012
(86) PCT No.: PCT/JP2012/062151

§ 371 Date: Nov. 12, 2013

(30) Foreign Application Priority Data
May 13, 2011 (JP) 2011-108081

(51) Int. Cl. H04W 24/08

(52) U.S. Cl. CPC H04W 24/08
USPC 370/252

(57) ABSTRACT

A wireless transmission path monitoring unit of a wireless device monitors the state of a wireless transmission path, transmits a PAUSE command stipulated in a MAC control protocol to a router, and performs a band limitation for the router regardless of a margin of a buffer when the state of the wireless transmission path has changed. In this way, it is possible to shorten the processing time until the band limitation is applied to the router after the state of the wireless transmission path changes, and to suppress transmission delay due to retransmission of transmission data.

### TECHNICAL FIELD

The present invention relates to a wireless device capable of performing transmission/reception of data in a wired manner and transmission/reception of data in a wireless manner, a router that relays data flowing between the wireless device and a network, and a method for high-speed optimization of wireless transmission.

### BACKGROUND ART

FIG. 9 is a block diagram illustrating a schematic configuration of a wireless system including a wireless device. In FIG. 9, a wireless system 7 includes a wireless device 10, and a router 20 that mutually connects a network 30 to the wireless device 10 and relays transmission data flowing between the network 30 and the wireless device 10. The wireless device 10 transmits/receives data to/from a second wireless device 50 in a wireless manner.

A wireless transmission speed between the wireless device 10 and the wireless device 50 changes according to the situational factors such as weather or interference. In the state in which transmission/reception of data is performed between the wireless device 10 and the wireless device 50 in a wireless manner, when the wireless transmission speed is reduced due to deterioration of the state of a wireless transmission path 40, transmission data transmitted from the wireless device 10 to the wireless device 50 is temporarily held in a buffer 103 in order to supplement the difference between a transmission speed of the data transmitted from the wireless device 10 and the wireless transmission speed. The amount of the transmission data which can be held in the buffer 103 increases/decreases in response to a change in the wireless transmission speed due to a change in the state of the wireless transmission path 40. When a deteriorated state of the wireless transmission path 40 is not recovered from, the amount of the transmission data temporarily held in the buffer 103 may exceed the capacity of the buffer 103. In such a case, the transmission data is discarded in order from the oldest or the lowest in priority.

Meanwhile, in order to reduce transmission data to be discarded, it is sufficient if the buffer 103 is prevented from overflowing. As one method thereof, there is a method in which control using a PAUSE command is performed for the router 20 by the wireless device 10 and thus the transmission of the transmission data is stopped. The PAUSE command used in this method is stipulated in a MAC (Media Access Control) control protocol. Using this method, the router 20 stops the transmission of the transmission data in response to a margin of the buffer 103. While the router 20 has stopped the transmission of the transmission data, the wireless device 10 transmits the transmission data of the buffer 103, so that it is possible to avoid overflow of the buffer 103.

FIG. 10 is a diagram illustrating a PAUSE frame stipulated in the MAC control protocol. “SFD” is an abbreviation for Start Frame Delimiter and “FCS” is an abbreviation for frame Check Sequence. In FIG. 10, as one method for performing flow control, there is a method using the PAUSE command stipulated in the MAC control protocol. The PAUSE command uses a PAUSE frame in which “01:80:C2:00:00:01” has been designated as a destination address of a MAC control frame, “0x8808” has been designated as a length/a type, “0x0001” has been designated as an operation code, and “0 to 65535” have been designated as a stop time.

A transmission side (the router 20) having received the PAUSE frame performs flow control by stopping transmission for the time of “the stop time x time of 512 bits” (512 bits is a minimum size of a frame) designated in a data field thereof. A reception side (the wireless device 10) transmits the PAUSE frame to the transmission side (the router 20) when remaining capacity of a buffer (the buffer 103) is small. The transmission side (the router 20) having received the PAUSE frame stops the transmission of the transmission data for the designated stop time or until the stop time is designated as “0.” When the buffer (the buffer 103) of the reception side (the wireless device 10) is sufficiently empty, the reception side (the wireless device 10) transmits a PAUSE frame with a stop time of “0” to the transmission side (the router 20).

Returning to FIG. 9, the transmission of the transmission data is stopped by the PAUSE command in response to the margin of the buffer 103 of the wireless device 10. While the router 20 stops the transmission of the transmission data, the wireless device 10 transmits the transmission data temporarily held in the buffer 103, so that the overflow of the buffer 103 is avoided.

In addition, technologies for determining an optimal transmission speed between a transmission station and a reception station using a wireless circuit and setting a transmission speed based on a result of the determination disclosed in Patent Document 1 and Patent Document 2 are other technologies associated with the present invention.

### DOCUMENTS OF THE PRIOR ART

### Patent Documents

[Patent Document 1]

Japanese Unexamined Patent Application No. 2004-015783

[Patent Document 2]

Japanese Unexamined Patent Application No. 2004-274537

### DISCLOSURE OF INVENTION

### Problems to be Solved by the Invention

However, in the aforementioned wireless system 7 illustrated in FIG. 9, since band limitation is performed by performing control using the PAUSE command for the router 20 in response to the margin of the buffer 103 of the wireless device 10, time is required for processing until the band limitation is applied to the router 20 after the state of the wireless transmission path 40 changes, resulting in the occurrence of transmission delay due to retransmission of the transmission data.

Furthermore, when the technologies disclosed in Patent Documents 1 and 2 are used, it is possible to control transmission for a partner that performs wireless communication. However, it is not possible to suppress transmission delay between a first partner and a second partner. For example, in FIG. 9, even when the technologies disclosed in Patent Documents 1 and 2 are used for the wireless device 10, it is not possible to suppress transmission delay between the wireless device 10 and the router 20.

An object of the present invention is to provide a wireless device, a router, a wireless system, and a method for high-speed optimization of wireless transmission, by which it is possible to solve the aforementioned problems.

### Means for Solving the Problem

In order to achieve the aforementioned objects, there is provided a wireless device includes: a wireless signal transmission/reception unit which modulates transmission data from a relay device, which relays the transmission data to a network side, to transmit modulated data to a second wireless device, and receives a high frequency signal transmitted from the second wireless device to demodulate transmission data; a buffer which temporarily holds transmission data transmitted/received by the wireless signal transmission/reception unit, and supplements a difference between processing speeds or transmission speeds at a time of transmission/reception of the transmission data; and a first wireless transmission path monitoring control unit which monitors a state of a wireless transmission path between the wireless device and the second wireless device, and applies a band limitation to the relay device when it is determined that the state of the wireless transmission path has deteriorated.

Furthermore, a router according to an embodiment of the present invention is the aforementioned wireless device, the first wireless transmission path monitoring control unit applies the band limitation by transmitting a PAUSE command stipulated in a MAC control protocol to the relay device. The router includes: a buffer which temporarily holds transmission data flowing between a wireless device, which transmits wireless transmission path information indicating the state of a wireless transmission path to the relay device, and a network, and supplements a difference between processing speeds or transmission speeds at a time of transmission/reception of the transmission data between the wireless device and the network; and a second wireless transmission path monitoring control unit which receives wireless transmission path information transmitted from the wireless device, and applies a band limitation to the network side when the wireless device determines that a state of the wireless transmission path has deteriorated from the received wireless transmission path information.

Furthermore, a wireless communication system according to a first embodiment of the present invention includes the aforementioned wireless device and the aforementioned router.

Furthermore, a method for high-speed optimization of wireless transmission according to a first embodiment of the present invention includes: a step of monitoring a state of a wireless transmission path between a first wireless device, which modulates transmission data from a relay device and transmits modulated data to a second wireless device, and the second wireless device, and acquiring wireless transmission speed information of the wireless transmission path, the relay device relaying the transmission data to a network side; a step of comparing the wireless transmission speed information acquired in the step with a wireless transmission speed threshold value; and a step of analyzing a result of the comparison in the step and applying a band limitation to the relay device when there is a change in the state of the wireless transmission path.

### Effects of the Invention

According to the present invention, it is possible to shorten a processing time until a band limitation is applied to a relay device that relays transmission data to a wireless device after the state of a wireless transmission path changes, and it is possible to suppress transmission delay due to retransmission of transmission data.

### BRIEF DESCRIPTION OF THE DRAWINGS

FIG. 1 is a block diagram illustrating a schematic configuration of a wireless system according to a first embodiment of the present invention.

FIG. 2 is a block diagram illustrating a schematic configuration of a wireless transmission path monitoring control unit of a wireless device according to a first embodiment of the present invention.

FIG. 3 is a sequence diagram showing a control operation when the state of a wireless transmission path has changed in a wireless system according to a first embodiment of the present invention.

FIG. 4 is a sequence diagram showing a detailed control operation of a wireless transmission path monitoring control unit when the state of a wireless transmission path has changed in a wireless system according to a first embodiment of the present invention.

FIG. 5 is a block diagram illustrating a schematic configuration of a wireless system according to a second embodiment of the present invention.

FIG. 6 is a block diagram illustrating a schematic configuration of a wireless transmission path monitoring control unit of a router of a wireless system according to a second embodiment of the present invention

FIG. 7 is a sequence diagram showing a control operation when the state of a wireless transmission path has changed in a wireless system according to a second embodiment of the present invention.

FIG. 8 is a sequence diagram showing a detailed control operation of a wireless transmission path monitoring control unit when the state of a wireless transmission path has changed in a wireless system according to a second embodiment of the present invention.

FIG. 9 is a block diagram illustrating a schematic configuration of a wireless system.

FIG. 10 is a diagram illustrating a PAUSE frame stipulated in a MAC control protocol.

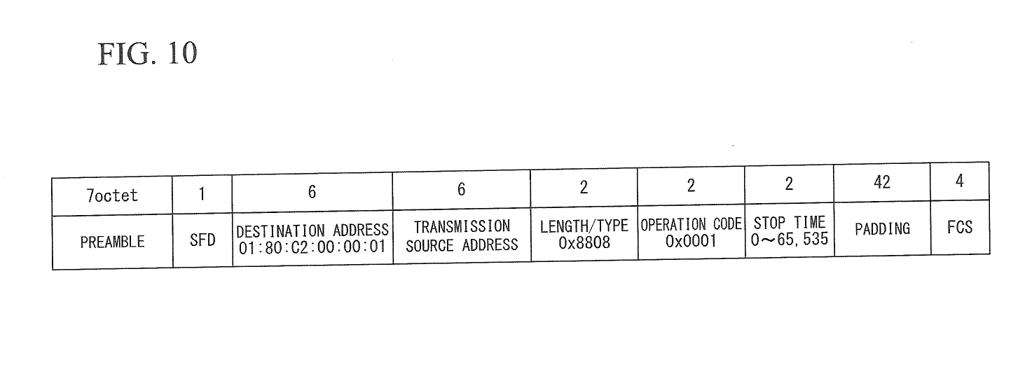

### EMBODIMENTS FOR CARRYING OUT THE INVENTION

Hereinafter, an embodiment of the present invention will be described with reference to the accompanying drawings.

### First Embodiment

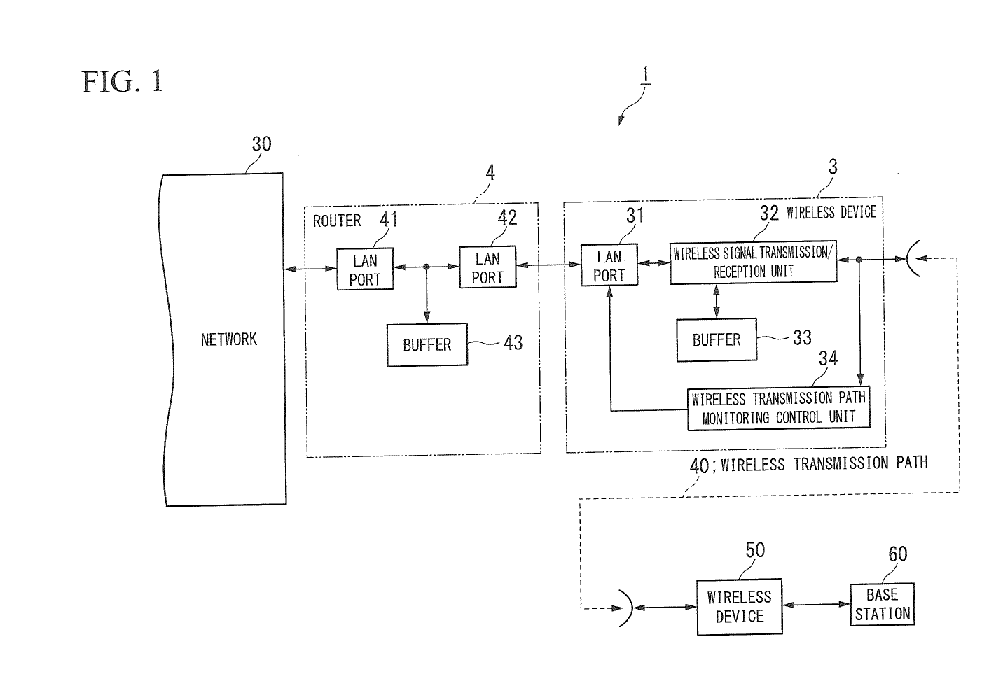

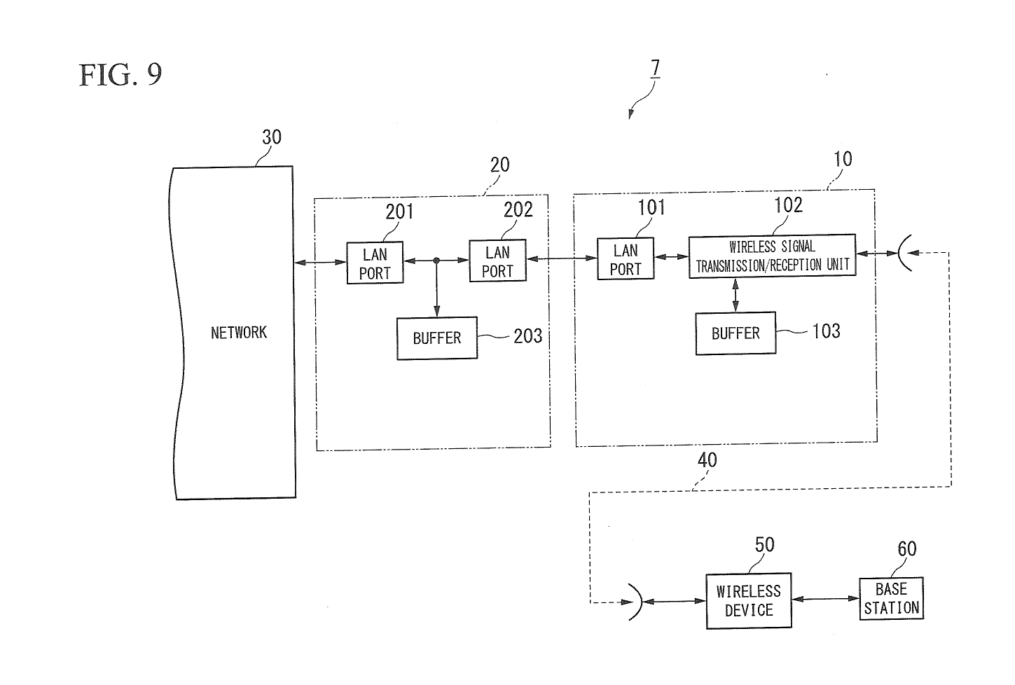

FIG. 1 is a block diagram illustrating a schematic configuration of a wireless system according to a first embodiment of the present invention. In addition, the same reference numerals are designated to parts of FIG. 1 common to those of FIG. 9 described above. A wireless system 1 in the first embodiment includes a wireless device 3, and a router (a device that relays transmission data) 4 that mutually connects a network 30 to the wireless device 3 and relays data flowing between the network 30 and the wireless device 3. The wireless device 3 transmits/receives data to/from a second wireless device 50 in a wireless manner.

The wireless device 3 includes a LAN port 31 that is connected to the router 4 in a wired manner, a wireless signal transmission/reception unit 32 that modulates transmission data received from the router 4 through the LAN port 31 to transmit the modulated data to the wireless device 50 via a wireless transmission path 40, receives a high frequency signal transmitted from the wireless device 50 via the wireless transmission path 40, demodulates transmission data, and outputs the demodulated data from the LAN port 31, a buffer 33 that temporarily holds transmission data in order to supplement the difference between processing speeds or transmission speeds at the time of transmission/reception of the transmission data between the wireless device 3 and the wireless device 50, and a wireless transmission path monitoring control unit 34 that monitors the wireless transmission path 40 and applies a band limitation to the router 4 upon detecting a change in the state of the wireless transmission path 40. The transmission data temporarily held in the buffer 33 of the wireless device 3 is sequentially transmitted in response to the difference between the processing speeds or the transmission speeds between the wireless device 3 and the wireless device 50. However, since the transmission data is prevented from being held beyond the capacity of the buffer 33, when the capacity of the buffer 33 is exceeded, the transmission data is discarded in order from the oldest or the lowest in priority.

The wireless transmission path monitoring control unit 34 of the wireless device 3 monitors the wireless transmission path 40, and compares acquired wireless transmission speed information with a threshold value of a wireless transmission speed stored in the wireless transmission path monitoring control unit 34, thereby determining the state of the wireless transmission path 40. When the wireless transmission speed information is analyzed and becomes less than the threshold value, the wireless transmission path monitoring control unit 34 determines that the state of the wireless transmission path 40 has deteriorated and performs control for applying a band limitation to the router 4. Furthermore, when the wireless transmission speed information exceeds the threshold value, the wireless transmission path monitoring control unit 34 determines that the state of the wireless transmission path 40 has been recovered and performs control to release the band limitation for the router 4.

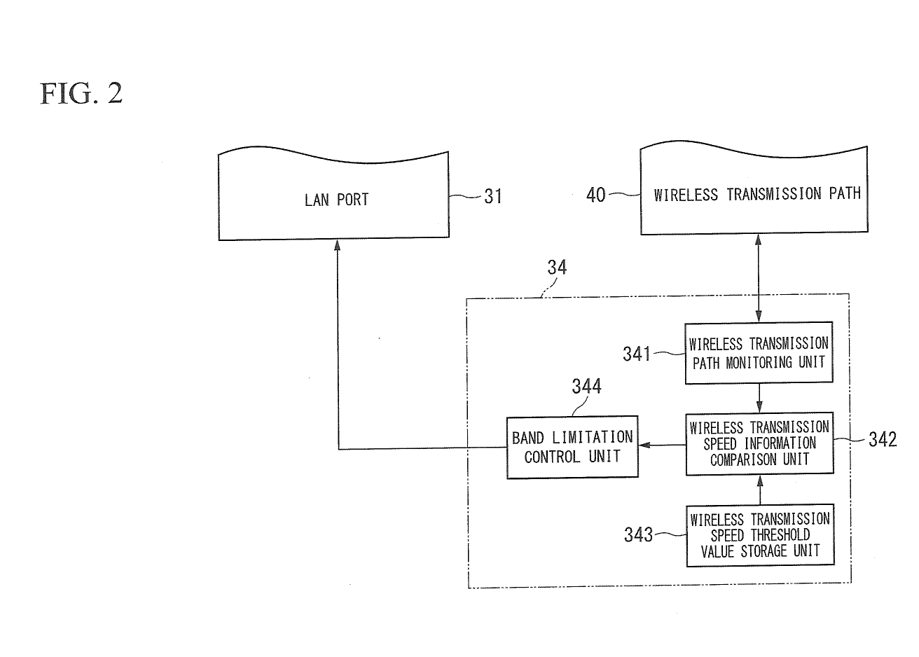

FIG. 2 is a block diagram illustrating a schematic configuration of the wireless transmission path monitoring control unit 34 of the wireless device 3 according to the first embodiment of the present invention.

In FIG. 2, the wireless transmission path monitoring control unit 34 includes a wireless transmission path monitoring unit 341, a wireless transmission speed information comparison unit 342, a wireless transmission speed threshold value storage unit 343, and a band limitation control unit 344. The wireless transmission path monitoring unit 341 monitors the state of the wireless transmission path 40, and acquires the wireless transmission speed information of the wireless transmission path 40. The wireless transmission path monitoring unit 341 outputs the acquired wireless transmission speed information to the wireless transmission speed information comparison unit 342. When the wireless transmission speed information output from the wireless transmission path monitoring unit 341 is input, the wireless transmission speed information comparison unit 342 acquires a wireless transmission speed threshold value stored in the wireless transmission speed threshold value storage unit 343, and compares the wireless transmission speed threshold value with the wireless transmission speed information. Then, the wireless transmission speed information comparison unit 342 outputs a result obtained by comparing the wireless transmission speed information with the wireless transmission speed threshold value to the band limitation control unit 344. The wireless transmission speed threshold value storage unit 343 stores the wireless transmission speed threshold value to be compared with the wireless transmission speed information acquired by the wireless transmission path monitoring unit 341. The band limitation control unit 344 receives and analyzes the comparison result output from the wireless transmission speed information comparison unit 342, and performs the band limitation when it is determined that there is a change in the state of the wireless transmission path 40.

Returning to FIG. 1, the router 4 mutually connects the network 30 to the wireless device 3, and relays transmission data flowing between the network 30 and the wireless device 3. The router 4 includes a LAN port 41 that is connected to the network 30, a LAN port 42 that is connected to the wireless device 3, and a buffer 43 that temporarily holds transmission data in order to supplement the difference between processing speeds or transmission speeds at the time of transmission/reception of the transmission data between the router 4 and the wireless device 3. The transmission data temporarily held in the buffer 43 is sequentially transmitted by the difference between the processing speeds or the transmission speeds between the router 4 and the wireless device 3. However, since the transmission data is prevented from being held beyond the capacity of the buffer 43, when the capacity of the buffer 43 is exceeded, the transmission data is discarded in order from the oldest or the lowest in priority.

The wireless transmission path 40 is a wireless transmission medium that performs transmission data transfer between the wireless device 3 and the wireless device 50. As described above, the situational factors of the wireless transmission path 40 is monitored by the wireless transmission path monitoring control unit 34 of the wireless device 3. The wireless device 50 receives transmission data transmitted from a base station 60 in a wireless manner to transmit the transmission data to the wireless device 3, and receives transmission data transmitted from the wireless device 3 to transmit the transmission data to the base station 60. The base station 60 is a base station for a general portable or data communication service that is operated using data that has gone through the wireless device 3 and the wireless device 50.

In addition, since the LAN port 31 of the wireless device 3 and the LAN ports 41 and 42 of the router 4 are well-known by those skilled in the art and are not directly related to the present invention, a detailed configuration thereof will be omitted. Furthermore, the router 4 may be replaced with a second network device having the same function as that of the router 4.

Next, an operation of the wireless system 1 in the first embodiment will be described.

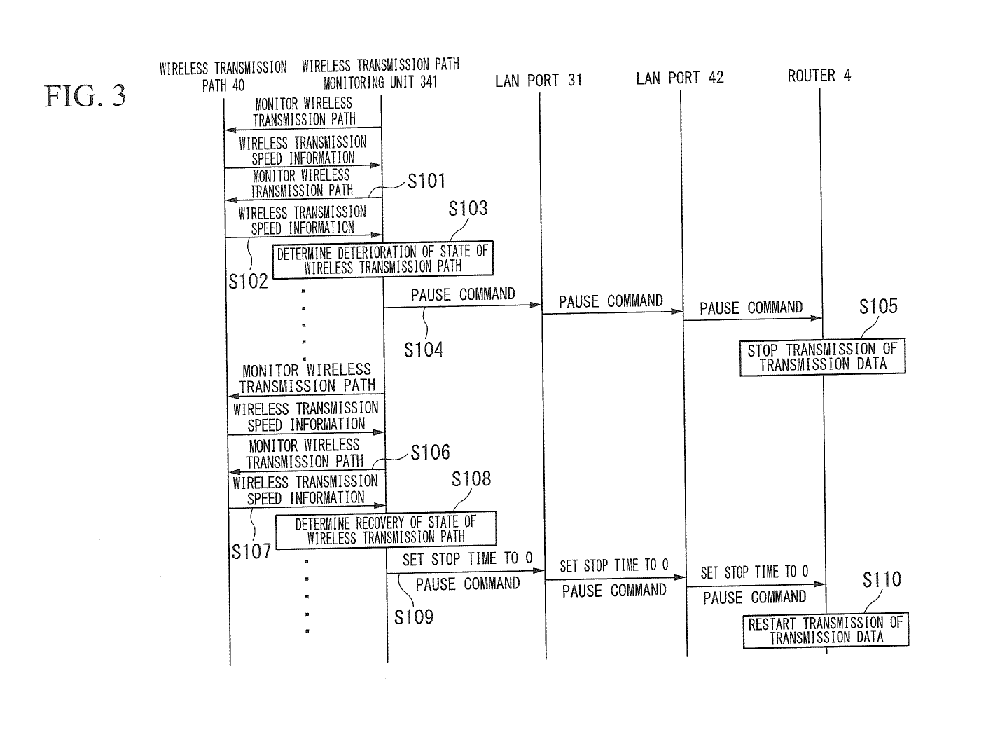

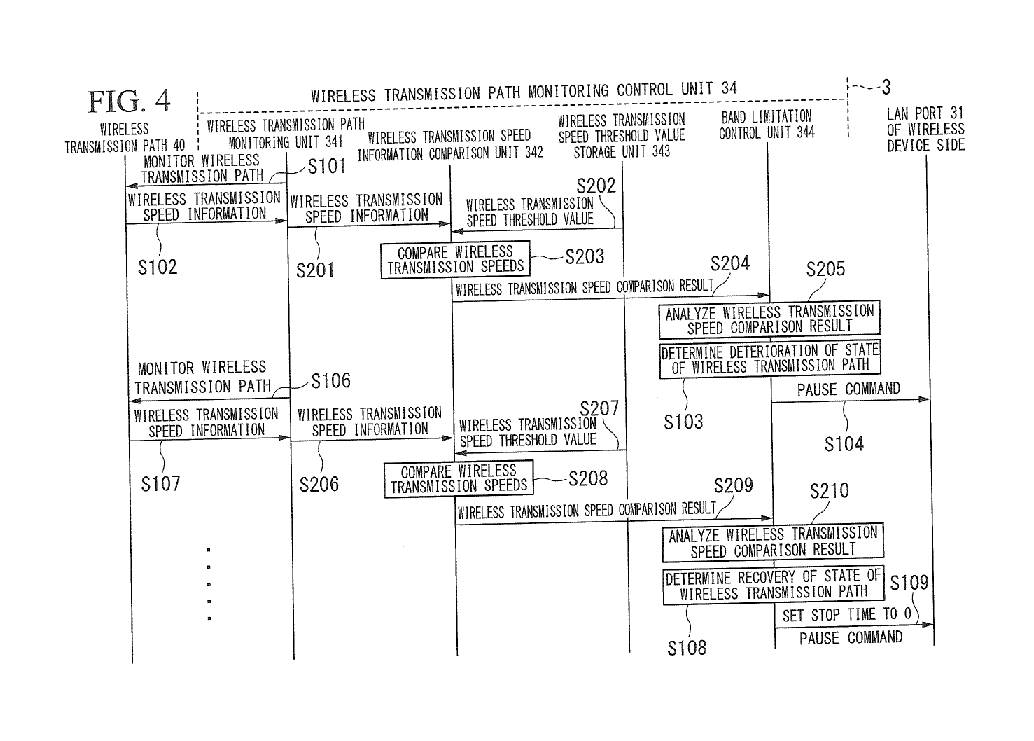

FIG. 3 is a sequence diagram for describing a control operation when the state of the wireless transmission path 40 has changed in the wireless system 1 of the first embodiment. FIG. 4 is a sequence diagram showing a detailed control operation of the wireless transmission path monitoring control unit 34 when the state of the wireless transmission path 40 has changed in the wireless system 1 of the first embodiment.

In FIG. 3 and FIG. 4, the wireless transmission path monitoring unit 341 of the wireless transmission path monitoring control unit 34 monitors the wireless transmission path 40 (S101). The wireless transmission path monitoring unit 341 monitors the wireless transmission path 40 to acquire the wireless transmission speed information indicating the transmission speed of the wireless transmission path 40 (S102). The wireless transmission path monitoring unit 341 outputs the acquired wireless transmission speed information to the wireless transmission speed information comparison unit 342 (S201). The wireless transmission speed information comparison unit 342 receives the wireless transmission speed information output from the wireless transmission path monitoring unit 341, acquires the wireless transmission speed threshold value stored in the wireless transmission speed threshold value storage unit 343 (S202), and compares the wireless transmission speed threshold value with the wireless transmission speed information (S203). Then, the wireless transmission speed information comparison unit 342 outputs a result of the comparison to the band limitation control unit 344 (S204). The band limitation control unit 344 receives the result of the comparison from the wireless transmission speed information comparison unit 342, analyzes the result of the comparison, and determines the state of the wireless transmission path 40 (S205).

When the result of the comparison output from the wireless transmission speed information comparison unit 342 becomes less than the threshold value, the band limitation control unit 344 determines that the state of the wireless transmission path 40 has deteriorated (S103) and applies a band limitation to the router 4. That is, the band limitation control unit 344 performs the band limitation for transmission data flowing between the router 4 and the wireless device 3. For example, the band limitation control unit 344 transmits the PAUSE command stipulated in the MAC control protocol to the router 4, thereby applying the band limitation (S104). The PAUSE command transmitted from the band limitation control unit 344 is transmitted to the router 4 via the LAN port 31.

When the PAUSE command transmitted from the band limitation control unit 344 is received, the router 4 stops the transmission of transmission data to the wireless device 3 by the PAUSE command (S105). The router 4 stops the transmission of the transmission data to the wireless device 3, so that the band limitation is applied to the transmission data flowing between the router 4 and the wireless device 3. The band limitation control by the PAUSE command from the wireless transmission path monitoring control unit 34 is performed regardless of a margin of the buffer 33 of the wireless device 3.

After the band limitation is performed, the wireless transmission path monitoring unit 341 restarts the monitoring of the wireless transmission path 40 (S106), and acquires wireless transmission speed information indicating the transmission speed of the wireless transmission path 40 (S107). Then, the wireless transmission path monitoring unit 341 outputs the acquired wireless transmission speed information to the wireless transmission speed information comparison unit 342 (S206). When the wireless transmission speed information output from the wireless transmission path monitoring unit 341 is received, the wireless transmission speed information comparison unit 342 acquires the wireless transmission speed threshold value stored in the wireless transmission speed threshold value storage unit 343 (S207), and compares the acquired wireless transmission speed threshold value with the wireless transmission speed information (S208). Then, the wireless transmission speed information comparison unit 342 outputs a result of the comparison to the band limitation control unit 344 (S209). The band limitation control unit 344 analyzes the result of the comparison output from the wireless transmission speed information comparison unit 342, and determines the state of the wireless transmission path 40 (S210).

When the result of the comparison exceeds the threshold value, the band limitation control unit 344 determines that the state of the wireless transmission path 40 has been recovered (S108) and releases the band limitation for the router 4. In order to release the band limitation, the band limitation control unit 344 transmits a PAUSE command with a stop time of “0” to the router 4 (S109). The PAUSE command transmitted from the band limitation control unit 344, with a stop time of “0,” is transmitted from the LAN port 31 to the router 4. When the PAUSE command transmitted from the band limitation control unit 344, with a stop time of “0,” is received, the router 4 restarts the transmission of the transmission data to the wireless device 3 and releases the band limitation of the router 4 (S110).

As described above, according to the wireless system 1 of the first embodiment, the wireless transmission path monitoring control unit 34 of the wireless device 3 monitors the state of the wireless transmission path 40, transmits the PAUSE command stipulated in the MAC control protocol to the router 4, and performs the band limitation for the router 4 regardless of the margin of the buffer 33 when the state of the wireless transmission path 40 has changed, so that it is possible to shorten a processing time until the band limitation is applied to the router 4 and to suppress transmission delay due to retransmission of transmission data. Furthermore, it is possible to suppress wasteful overhead due to the retransmission of the transmission data and to suppress the reduction of a backward transmission rate. Furthermore, it is possible to always optimize a transmission rate due to the processing reduction of the band limitation, so that it is possible to reduce the capacity of the buffer 33.

### Second Embodiment

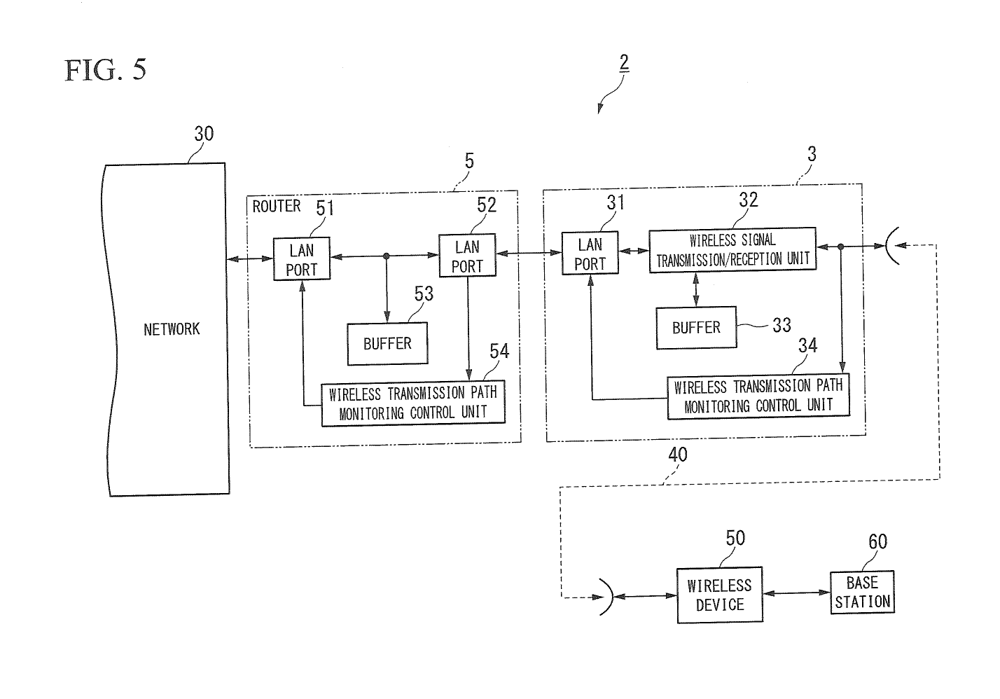

FIG. 5 is a block diagram illustrating a schematic configuration of a wireless system according to a second embodiment of the present invention.

A wireless system 2 in the second embodiment includes a router provided with a wireless transmission path monitoring control unit equivalent to the wireless transmission path monitoring control unit 34 provided in the wireless device 3 of the wireless system 1 of the aforementioned first embodiment.

In FIG. 5, a wireless transmission path monitoring control unit 54 of a router 5 receives wireless transmission path information transmitted from the wireless transmission path monitoring control unit 34 of the wireless device 3 side, and determines the state of a wireless transmission path 40 based on the received wireless transmission path information. Then, when it is determined that the state of the wireless transmission path 40 has deteriorated, the wireless transmission path monitoring control unit 54 performs control for applying a band limitation to a network 30. Furthermore, when it is determined that the state of the wireless transmission path 40 has been recovered based on the wireless transmission path information received from the wireless transmission path monitoring control unit 34 of the wireless device 3 side, the wireless transmission path monitoring control unit 54 performs is control to release the band limitation for the network 30. In addition, LAN ports 51 and 52 and a buffer 53 of the router 5 are the same as the LAN ports 41 and 42 and the buffer 43 of the router 4 of the first embodiment.

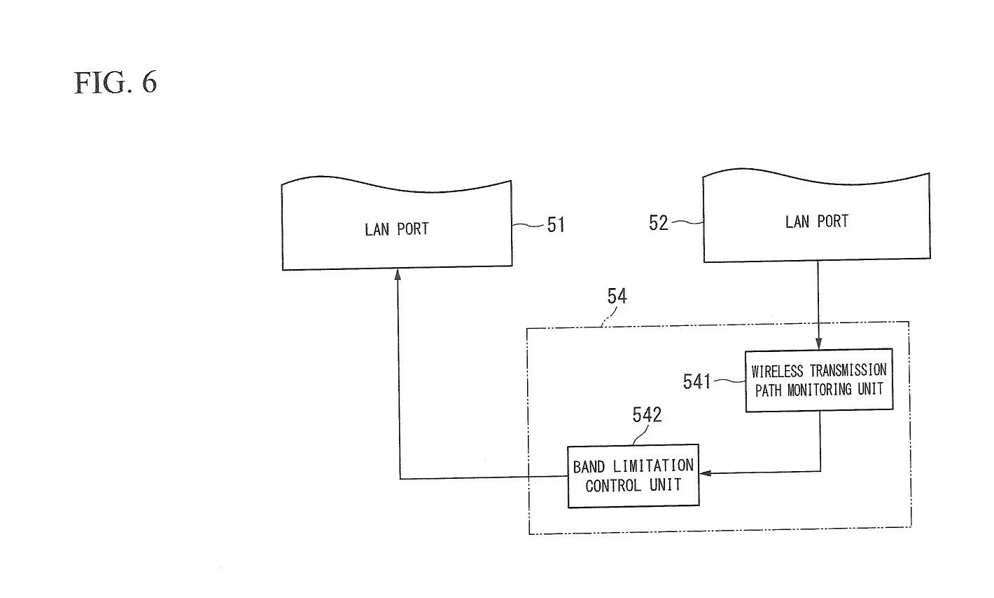

FIG. 6 is a block diagram illustrating a schematic configuration of the wireless transmission path monitoring control unit 54 of the router 5. In FIG. 6, the wireless transmission path monitoring control unit 54 includes a wireless transmission path monitoring unit 541 and a band limitation control unit 542. The wireless transmission path monitoring unit 541 receives wireless transmission speed information transmitted from the wireless device 3 and indicating a transmission speed of the wireless transmission path 40, and determines the deterioration of the state of the wireless transmission path 40 based on the received wireless transmission speed information. When the wireless transmission path monitoring unit 541 determines that the state of the wireless transmission path 40 has deteriorated, the band limitation control unit 542 performs control to apply the band limitation to the network 30.

Next, an operation of the wireless system 2 in the second embodiment will be described.

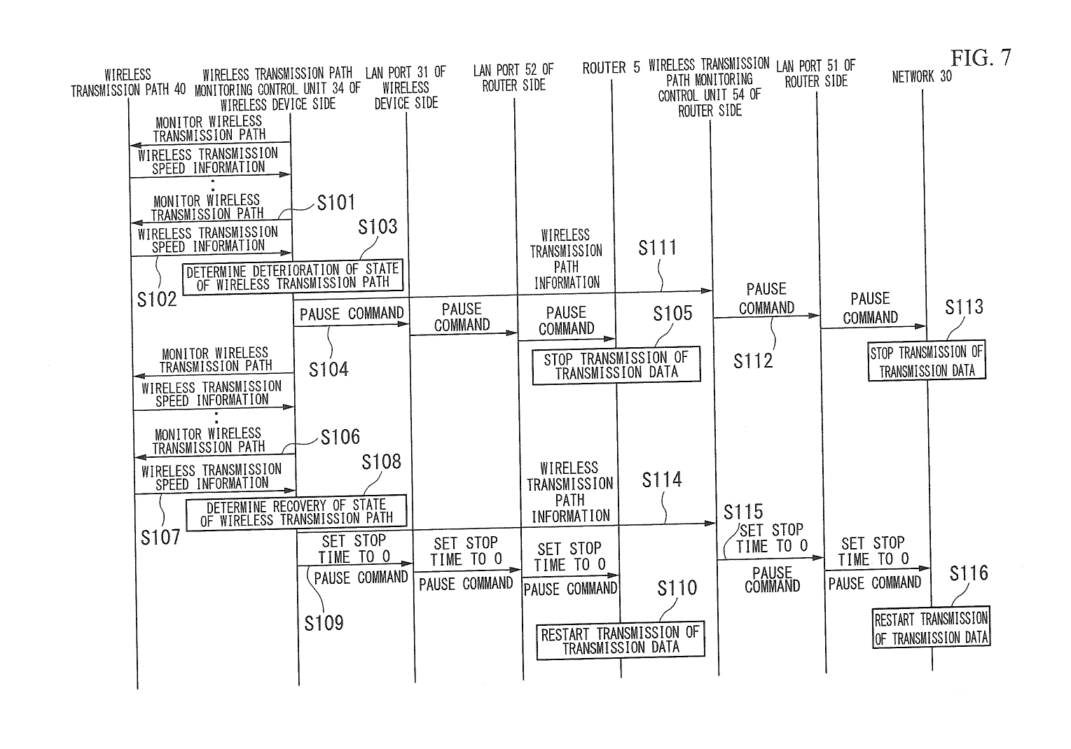

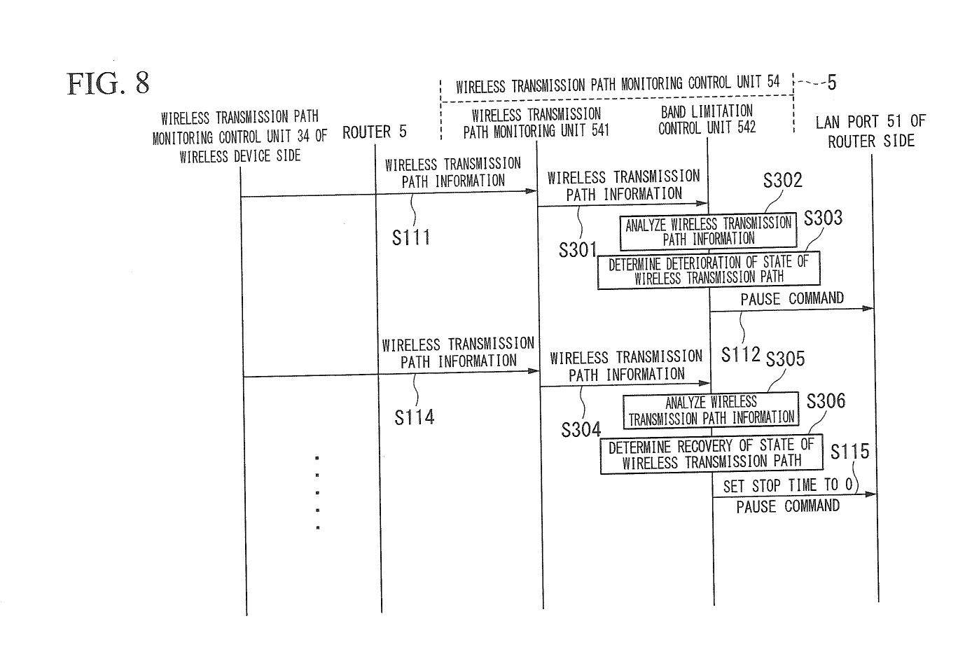

FIG. 7 is a sequence diagram for describing a control operation when the state of the wireless transmission path 40 has changed in the wireless system 2 of the second embodiment. FIG. 8 is a sequence diagram for describing a detailed control operation of the wireless transmission path monitoring control unit 54 when the state of the wireless transmission path 40 has changed in the wireless system 2 according to the second embodiment.

In FIG. 7 and FIG. 8, the wireless transmission path monitoring control unit 34 of the wireless device 3 side monitors the wireless transmission path 40 (S101). The wireless transmission path monitoring control unit 34 monitors the wireless transmission path 40 to acquire the wireless transmission speed information indicating the transmission speed of the wireless transmission path 40 (S102). When it is determined that the state of the wireless transmission path 40 has deteriorated (S103), the wireless transmission path monitoring control unit 34 performs the band limitation for the router 5. For example, the wireless transmission path monitoring control unit 34 transmits the PAUSE command stipulated in the MAC control protocol to the router 5 (S104). In addition, after the wireless transmission speed information is acquired and until the band limitation is performed, the same processes as the processes 5201 to S205 described in the wireless system 1 of the first embodiment are performed.

When the PAUSE command transmitted from the wireless transmission path monitoring control unit 34 is received, the router 5 stops the transmission of transmission data to the wireless device 3 according to the received PAUSE command (S105). The router 5 stops the transmission of the transmission data to the wireless device 3, so that the band limitation is applied to the router 5. In addition, the band limitation control by the PAUSE command from the wireless device 3 is performed regardless of a margin of the buffer 33 of the wireless device 3.

Furthermore, the wireless transmission path monitoring control unit 34 transmits the PAUSE command to the router 5, and simultaneously transmits the wireless transmission path information indicating the state of the wireless transmission path 40 to the wireless transmission path monitoring unit 541 of the wireless transmission path monitoring control unit 54 of the router 5 side (S111). When the wireless transmission path information transmitted from the wireless transmission path monitoring control unit 34 of the wireless device 3 side is received, the wireless transmission path monitoring unit 541 outputs the wireless transmission path information to the band limitation control unit 542 (S301). The band limitation control unit 542 receives and analyzes the wireless transmission path information output from the wireless transmission path monitoring unit 541, and determines the state of the wireless transmission path 40 (S302). When it is determined that the state of the wireless transmission path 40 deteriorates (S303), the band limitation control unit 542 transmits the PAUSE command to the LAN port 51 of the router 5 side (S112).

The PAUSE command transmitted from the band limitation control unit 542 is received in the network 30 by passing through the LAN port 51. The network 30 stops the transmission of transmission data to the router 5 according to the received PAUSE command, so that the band limitation is performed for the network 30 (S113). In addition, the band limitation control by the PAUSE command from the wireless transmission path monitoring control unit 54 of the router 5 side is performed regardless of the margin of the buffer 53 of the router 5.

Next, after the band limitation is performed, the wireless transmission path monitoring control unit 34 restarts the monitoring of the wireless transmission path 40 (S106). The wireless transmission path monitoring control unit 34 monitors the wireless transmission path 40 to acquire the wireless transmission speed information indicating the transmission speed of the wireless transmission path 40 (S107). Then, when it is determined from the acquired wireless transmission speed information that the state of the wireless transmission path 40 has been recovered (S108), the wireless transmission path monitoring control unit 34 releases the band limitation for the router 5. In order to release the band limitation, the wireless transmission path monitoring control unit 34 transmits a PAUSE command with a stop time of “0” to the router 5 (S109).

When the PAUSE command transmitted from the wireless transmission path monitoring control unit 34 of the wireless device 3, with a stop time of “0,” is received, the router 5 restarts the transmission of the transmission data to the wireless device 3 according to the received PAUSE command, with stop time of “0,” and releases the band limitation for transmission data flowing between the router 5 and the wireless device 3 (S110).

Furthermore, the wireless transmission path monitoring control unit 34 transmits the PAUSE command, with a stop time of “0,” to the router 5, and simultaneously transmits the wireless transmission path information indicating the state of the wireless transmission path 40 to the wireless transmission path monitoring control unit 54 of the router 5 side (S114). When the wireless transmission path information transmitted from the wireless transmission path monitoring control unit 34 is received, the wireless transmission path monitoring unit 541 of the wireless transmission path monitoring control unit 54 outputs the wireless transmission path information to the band limitation control unit 542 (S304). The band limitation control unit 542 receives and analyzes the wireless transmission path information output from the wireless transmission path monitoring unit 541, and determines the state of the wireless transmission path 40 (S305). As a result obtained by analyzing the wireless transmission path information, when it is determined that the state of the wireless transmission path 40 has been recovered (S306), the band limitation control unit 542 transmits the PAUSE command, with a stop time of “0,” to the network 30 (S115).

When the PAUSE command transmitted from the band limitation control unit 542, with a stop time of “0,” is received, the network 30 restarts the transmission of the transmission data to the router 5 according to the received PAUSE command, with a stop time of “0,” and releases the band limitation for the network 30 (S116).

As described above, according to the wireless system 2 of the second embodiment, the router 5 including the wireless transmission path monitoring control unit 54 is provided, and the wireless transmission path monitoring control unit 54 receives the wireless transmission path information transmitted from the wireless transmission path monitoring control unit 34 of the wireless device 3 side, and transmits the PAUSE command stipulated in the MAC control protocol to the network 30 and performs the band limitation for the network 30 regardless of the margin of the buffer 53 when the state of the wireless transmission path 40 has changed based on the received wireless transmission path information, so that it is possible to shorten a processing time until the band limitation is applied to the network 30 and to suppress transmission delay due to retransmission of transmission data. Furthermore, it is possible to suppress wasteful overhead due to the retransmission of the transmission data and to suppress the reduction of a backward transmission rate. Furthermore, it is possible to always optimize a transmission rate due to the processing reduction of the band limitation, so that it is possible to reduce the capacity of the buffer 53.

In the wireless system 2 of the second embodiment, since the router 5 side performs the band limitation for the network 30, the wireless device 3 side need not always perform the band limitation, and it is sufficient if only the wireless transmission path information is transmitted to the router 5 side.

Furthermore, as hardware configurations of the wireless transmission path monitoring control units 34 and 54 according to the first and second embodiments of the present invention, a normal computer is available. That is, the wireless transmission path monitoring control unit 34 of the wireless device 3 and the wireless transmission path monitoring control unit 34 of the router 5 may be configured by a computer including a storage medium such as a CPU or a RAM, a nonvolatile storage medium such as a ROM, and a large capacity storage device such as a hard disk.

Furthermore, programs having stored respective processes in the wireless transmission path monitoring control units 34 and 54 according to the first embodiment and the second embodiment of the present invention may be stored in a storage medium, such as a magnetic disk, an optical disc, a magneto-optical disc, or a semiconductor memory, for distribution.

The application is based on and claims the benefit of priority from prior Japanese Patent Application No. 2011-108081, filed May 13, 2011, the entire contents of which are incorporated herein.

### INDUSTRIAL APPLICABILITY

The present invention is applicable to a wireless system that performs data transmission in a wireless manner. It is possible to obtain a wireless device, a router, and a method for high-speed optimization of wireless transmission, by which it is possible to shorten a processing time until a band limitation is applied to a device that relays transmission data to the wireless device, after the state of a wireless transmission path changes.

### DESCRIPTION OF REFERENCE SYMBOLS

1 Wireless system
2 Wireless system
3 Wireless device
4 Router
Router
30 Network
31 LAN port
32 Wireless signal transmission/reception unit
33 Buffer
34 Wireless transmission path monitoring control unit
40 Wireless transmission path
41 LAN port
42 LAN port
43 Buffer
50 Wireless device
51 LAN port
52 LAN port
53 Buffer
54 Wireless transmission path monitoring control unit
60 Base station
341 Wireless transmission path monitoring unit
342 Wireless transmission speed information comparison unit
343 Wireless transmission speed threshold value storage unit
344 Band limitation control unit
541 Wireless transmission path monitoring unit
542 Band limitation control unit

1. A wireless device comprising:
a wireless signal transmission/reception unit configured to modulate transmission data from a relay device relaying the transmission data to a network side, transmit modulated data to a second wireless device, and receive a high frequency signal transmitted from the second wireless device to demodulate transmission data;
a buffer configured to temporarily hold transmission data transmitted/received by the wireless signal transmission/reception unit, and supplement a difference between processing speeds or transmission speeds at a time of transmission/reception of the transmission data; and
a first wireless transmission path monitoring control unit configured to monitor a state of a wireless transmission path between the wireless device and the second wireless device, and apply a band limitation to the relay device when it is determined that the state of the wireless transmission path has deteriorated.

2. The wireless device according to claim 1, wherein the first wireless transmission path monitoring control unit transmits a PAUSE command stipulated in a MAC control protocol to the relay device, thereby applying the band limitation.

3. The wireless device according to claim 1, wherein the first wireless transmission path monitoring control unit transmits wireless transmission path information indicating the state of the wireless transmission path to the relay device that relays the transmission data.

4. A router comprising:
a buffer which temporarily configured to hold transmission data flowing between the wireless device according to claim 3 and the network, and supplement a difference between processing speeds or transmission speeds at a time of transmission/reception of the transmission data between the wireless device and the network; and
a second wireless transmission path monitoring control unit configured to receive wireless transmission path information transmitted from the wireless device, and apply a band limitation to the network side when the wireless device determines that a state of a wireless transmission path has deteriorated from the received wireless transmission path information.

5. The router according to claim 4, wherein the second wireless transmission path monitoring control unit transmits a PAUSE command stipulated in a MAC control protocol to the network side, thereby applying the band limitation.

6. A wireless system comprising:
the wireless device according to claim 3; and
a router that comprises
a buffer which temporarily configured to hold transmission data flowing between the wireless device according to claim 3 and the network, and supplement a difference between processing speeds or transmission speeds at a time of transmission/reception of the transmission data between the wireless device and the network; and
a second wireless transmission path monitoring control unit configured to receive wireless transmission path information transmitted from the wireless device, and apply a band limitation to the network side when the wireless device determines that a state of a wireless transmission path has deteriorated from the received wireless transmission path information.

7. A method for high-speed optimization of wireless transmission, comprising:
a step of monitoring a state of a wireless transmission path between a first wireless device, which modulates transmission data from a relay device and transmits modulated data to a second wireless device, and the second wireless device, and acquiring wireless transmission speed information of the wireless transmission path, the relay device relaying the transmission data to a network side;
a step of comparing the wireless transmission speed information acquired in the step with a wireless transmission speed threshold value; and
a step of analyzing a result of the comparison in the step and applying a band limitation to the relay device when there is a change in the state of the wireless transmission path.
